(19) United States
(12) Patent Application Publication
(10) Pub. No.: US 2026/0132599 A1
(43) Pub. Date: May 14, 2026

(54) AUTONOMOUS MINE MONITOR

(71) Applicant: Microchip Technology Incorporated, Chandler, AZ (US)

(72) Inventors: Patrick Shane MCFARLAND, Gilbert, AZ (US); Steve NAGEL, Chandler, AZ (US); Bomy CHEN, Newark, CA (US); Art B. ECK, Gilbert, AZ (US)

(21) Appl. No.: 19/301,927

(22) Filed: Aug. 15, 2025

Related U.S. Application Data
(60) Provisional application No. 63/719,642, filed on Nov. 12, 2024.

(51) Int. Cl. E02F 9/26; G01N 21/3563; G01N 21/71; G01N 24/08; G05D 1/24; G05D 101/15; G05D 105/80; G05D 107/70; G05D 109/12; G05D 111/10

(52) U.S. Cl. CPC E02F 9/262; G01N 21/3563; G01N 21/71; G01N 24/081; G05D 1/24; G01N 2201/0216; G05D 2101/15; G05D 2105/80; G05D 2107/73; G05D 2109/12; G05D 2111/14

(57) ABSTRACT

In some implementations, a mobile unit may analyze dust at a location. The dust may be analyzed using a machine learning model trained to analyze the dust data to determine presence of ores. The mobile unit may detect a presence of ore at the location based on analyzing the dust data. The mobile unit may generate mining information based on detecting the presence of the ore at the location. The mining information indicates the presence of the ore at the location. The mining information identifies the location. The mobile unit may provide the mining information to a mining machine to cause the mining machine to perform a digging operation at the location.

### RELATED APPLICATION

This application claims priority to U.S. Provisional Patent Application No. 63/719,642, entitled “AUTONOMOUS MINE MONITOR,” filed Nov. 12, 2024, which is incorporated herein by reference in its entirety.

### FIELD

The present disclosure generally relates to mining operations and, for example, relates to determining a location for performing a digging operation.

### BACKGROUND

A mine, as used herein, may refer to a location where natural resources are covered by dirt, earth, and/or similar material. In this regard, a mining operation is an operation performed at a mine in which the dirt (or earth) is excavated to uncover and extract the natural resources. The natural resources may include ore and minerals, among other examples. The mining operation may be performed using a mining machine.

### BRIEF DESCRIPTION OF THE DRAWINGS

FIG. 1 is a diagram of an example implementation described herein.

FIG. 2 is a diagram of an example mobile unit described herein.

FIG. 3 is a diagram of example components of one or more devices of FIGS. 1-2.

FIG. 4 is a flowchart of an example process associated with autonomous mine monitoring described herein.

FIG. 5 is a diagram of an example dust data described herein.

### DETAILED DESCRIPTION

The following detailed description of example implementations refers to the accompanying drawings. The same reference numbers in different drawings may identify the same or similar elements.

A mining operation may be performed at a mine to excavate and extract ore and minerals, among other natural resources. Typically, the mining operation is performed using a mining machine, such as an excavator. The mining operation may involve performing an analysis of the ore to ascertain information regarding the ore, such as a type of the ore, a quality of the ore, a purity of the ore, and one or more other natural resources that have been combined with the ore over time, among other examples.

Currently, mining operations are time-consuming processes. For example, the analysis of the ore may take days to weeks to determine the type of the ore, the quality of the ore, and the one or more other natural resources that have been combined with the ore over time, among other examples. Successfully and accurately performing the analysis may increase yield in operation that identify and pursue rich veins at the mine. As used herein, “rich veins” may refer to locations at the mine with a selected quantity and/or a selected concentration of ore.

While successfully and accurately performing the analysis may increase the yield, the analysis remains a time-consuming process, that takes up multiple weeks to ascertain the information regarding the process. For example, the ore may be transported to a location remote from the mine for the analysis to be performed. Additionally, algorithms for performing the analysis may be complex and, accordingly, may cause delays with respect to generating results of the analysis. While the analysis is being performed, the mining operations may be suspended at the mine. Accordingly, the analysis may cause significant downtime at the mine because mining machines and operators may be awaiting the results of the analysis before resuming the mining operations. The cycle time of the analysis may be significant. As a result, the analysis may decrease productivity at the mine. Accordingly, a need exists to efficiently analyze ores in a manner to improve productivity at the mine.

Implementations described herein are directed to a process using a mobile unit in conjunction with a mining machine to find locations (at a mine) of deposits of ores and to improve mining the locations with the best return on investment in real time. The mobile unit may operate in conjunction with a mining machine. For example, the process may involve using dust, in a mine, as an indicator of richness of the deposits of ores to be mined. For instance, the process may involve the mobile unit analyzing dust data, regarding the dust, to determine different types of ores at different locations of a mine. In some implementations, the mobile unit may include a sensing component that is used to generate the dust data regarding the dust. In some examples, the mobile unit may include a robot dog and the sensing component may include a spectrometer.

In some implementations, the process may involve the mobile unit blowing up dust, igniting the dust with onboard fuel (e.g., onboard the mobile unit) to generate a flame, and performing an analysis of the flame to determine a spectral energy of the flame. For example, the mobile unit perform an analysis of the flame to determine different wavelengths (e.g., colors) and intensities of the different wavelengths. For instance, the spectrometer may be used to determine the different wavelengths and the intensities of the different wavelengths. In this regard, the dust data may identify the different wavelengths and the intensities. Based on the different wavelengths and the intensities, the mobile unit may determine elements in the dust (e.g., determine different types of ores in the flame).

In some implementations, in addition or alternative to analyzing the flame, the mobile unit may determine a nuclear magnetic resonance of the dust. In some examples, the mobile unit may use the spectrometer to determine the nuclear magnetic resonance of the dust. In this regard, the dust data may indicate the nuclear magnetic resonance of the dust. The nuclear magnetic resonance may indicate the composition of the dust (e.g., the elements in the dust).

The dust data may be provided to a machine learning model (onboard the mobile unit) that is trained to analyze data regarding spectral energy to determine (e.g., predict) presence of ores. In some examples, the machine learning model may be trained to analyze the spectral energy of the flame to determine the elements in the dust. In some examples, the machine learning model may be trained to analyze the nuclear magnetic resonance of the dust to determine the presence of the elements in the dust. In other words, the analysis of the dust data may be performed by the mobile unit using the machine learning model. As a result of the machine learning model analyzing the dust data, the analysis cycle time of the dust may be reduced to real time or near real time.

In some implementations, the mobile unit may receive ore information identifying a type of ore to be detected in the mine. In some situations, the ore information may identify a concentration of ore, identify a desired combination of ores, or identify an undesired combination of ores, among other examples. In some examples, the ore information may be received from a device of an operator associated with the mobile unit. Based on the ore information, the mobile unit may analyze the dust data (using the sensing component and the machine learning model) to determine whether the dust includes the type of ore and the concentration of ore identified by the ore information.

In some implementations, the mobile unit may generate mining information based on detecting the presence of the ore at the location. The mining information may indicate the presence of the ore at the location, indicate a concentration of the ore in the dust, and identify the location (e.g., geographical coordinates of the location). The mobile unit may provide the mining information to the mining machine. In this regard, the mining machine may be directed to the location where the mobile unit detected the presence of the ore (e.g., the richest deposits).

In some implementations, the mining information may cause (e.g., instruct) the mining machine to navigate to the location and initiate a digging operation at the location. The mining machine may provide a sample of material (obtained as a result of the digging operation) to a material processing device (e.g., an edge device) for analysis. The material processing device may generate digging information indicating whether the ore was located as a result of performing the digging operation at the location. Additionally, or alternatively, the digging information may indicate a concentration of the ore at the location. In this regard, implementations described herein may compare the prediction of the machine learning model to a result of the material processing device processing the material. The digging information may provide an indication of false positive feedback and/or false negative feedback based on the comparison.

The false positive feedback may be provided if the machine learning model predicts the presence of the ore at the location and the material processing device does not detect the ore. Conversely, the false negative feedback may be provided if the machine learning model predicts the absence of the ore at the location and the material processing device does detect the ore. The false positive feedback and the false negative feedback may be used to re-train the machine learning model to improve a prediction of the machine learning model.

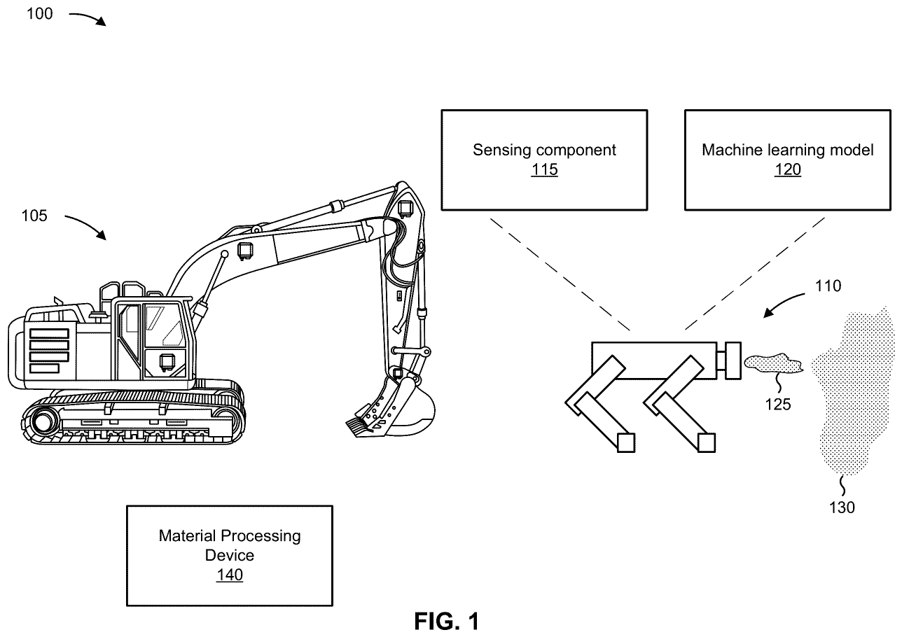

FIG. 1 is a diagram of an example implementation 100 as described herein. As shown in FIG. 1, implementation 100 may include a mining machine 105, a mobile unit 110, and a material processing device 140. As shown in FIG. 1, mining machine 105 may include an excavator. In some situations, mining machine 105 may be a machine different than an excavator, such as a loader, a hydraulic mining shovel, or a mining truck, among other examples. In some examples, mining machine 105 may transport equipment for mobile unit 110, such as batteries (e.g., replacement batteries), fuel, and sensing components (e.g., replacement sensing components), among other examples. For instance, mining machine 105 may transport heavy batteries and fuel. The mining maching 105 may include equipment which can easily recharge the heavy battery and carry the fuel. Mining machine 105 may transport low-cost back up equipment for mobile unit 110 (e.g., replacement components for mobile unit 110).

Mining machine 105 may be controlled by an operator onboard mining machine 105. In some implementations, mining machine 105 may be controlled by an operator located remotely from mining machine 105. In some implementations, mining machine 105 may be an autonomous machine or a semiautonomous machine.

Mobile unit 110 may analyze dust data regarding dust 130 in the mine to determine the presence of a type of ore. The type of ore may be identified by an operator associated with mining machine 105 and/or associated with mobile unit 110. As shown in FIG. 1, mobile unit 110 may include a sensing component 115 and a machine learning model 120. In some examples, sensing component 115 may include a spectrometer or a spectroscope. For example, sensing component 115 may include an infrared spectrometer, a mass spectrometer, or a nuclear magnetic resonance (NMR) spectrometer, among other examples. In some examples, sensing component 115 may measure the spectral energy of a flame (resulting from igniting dust 130).

As shown in FIG. 1, for example, mobile unit 110 may project a flame 125 to ignite dust 130. Flame 125 may be a controllable flame. Flame 125 may be projected from a head portion of mobile unit 110. In some examples, sensing component 115 may measure one or more frequencies returned to sensing component 115. In this regard, sensing component 115 may generate the dust data. The dust data may include data regarding the spectral energy (e.g., data identifying one or more frequencies and one or more intensities of the one or more frequencies). The one or more frequencies may correspond to one or more colors. Accordingly, the dust data may identify different colors. In some examples, sensing component 115 may measure the nuclear magnetic resonance of dust 130. In this regard, sensing component 115 may generate the dust data and the dust data may include data regarding the nuclear magnetic resonance of dust 130. For example, the dust data may include data identifying one or more radiofrequencies and/or intensities of the radiofrequencies.

In some examples, sensing component 115 may measure one or more frequencies returned to sensing component 115 as a result of dust 130 being ignited. For example, in some implementations, sensing component 115 may include a photo sensor for measuring a light spectrum of dust 130 when dust 130 burns. In this regard, sensing component 115 may generate the dust data. The dust data may include data identifying one or more frequencies, one or more intensities of the one or more frequencies, and a corresponding spectral energy at the one or more frequencies. The one or more frequencies may correspond to one or more colors and the one or more intensities may correspond to a brightness of the one or more colors. Accordingly, the dust data may identify different colors. In some examples, a color may indicate a presence of an element (e.g., an ore) in dust 130 and a brightness of the color may indicate a concentration of the element in dust 130.

In some examples, sensing component 115 may include a mass spectrometer that may directly measure dust 130 by way of displacement in a magnetic field. For example, based on a displacement of ions (in dust 130) in a magnetic field, the mass spectrometer may measure mass-to-charge ratio of the ions. The mass-to-charge ration may be used to identify molecules or atoms in dust 130, thereby identifying the composition of dust 130 (e.g., thereby identifying elements in dust 130). With respect to the mass spectrometer, the dust data may include data identifying the displacement of ions (in dust 130) in the magnetic field, the mass-to-charge ratio of the ions, and/or the molecules or atoms in dust 130. In contrast to the photo sensor, the mass spectrometer may measure dust 130 without dust 130 being ignited.

In some examples, sensing component 115 may measure the nuclear magnetic resonance of dust 130. For example, sensing component 115 may include a nuclear magnetic resonance spectrometer that may use a strong magnetic field and high frequency electromagnetic (EM) waves (radio waves) and then measure how the dust disturbs the waves. In this regard, sensing component 115 may generate the dust data and the dust data may include data regarding the nuclear magnetic resonance of dust 130 (e.g., data regarding a response of dust 130 to one or more radiofrequency pulses applied in the presence of the magnetic field). The dust data may include data identifying one or more radiofrequencies and/or intensities of the radiofrequencies.

Sensing component 115 may include sensing equipment (as described above) that can be easily replaceable, thereby lowering equipment cost of mobile unit 110 and reducing possible down time of mobile unit 110. In some instances, mining machine 105 may transport one or more sensing components.

Machine learning model 120 may include a convolutional neural network, a recurrent neural network, or a transformer neural network, among other examples. Machine learning model 120 may be trained to analyze the dust data to determine the presence of the ore at a location of mobile unit 110 and/or a concentration (or an amount) of the ore at the location, among other examples.

For example, machine learning model 120 may be trained with training data that identifies different frequencies, different types of ores associated with the different frequencies, and different intensities associated with the different frequencies, For instance, the training data may include data identifying a first frequency (or a first range of frequencies), data indicating that the first frequency (or the first range of frequencies) identifies a first type of ore, and data indicating that a first intensity identifies a first concentration of the first type of ore. The training data may include data identifying a second frequency (or a second range of frequencies), data indicating that the second frequency (or the second range of frequencies) identifies a second type of ore, and data indicating that a second intensity identifies a second concentration of the second type of ore. Accordingly, machine learning model 120 may be trained to identify different predicted types of ores and predicted concentrations of the different predicted types of ores based on different frequencies and different intensities identified by the dust data.

With respect to nuclear magnetic resonance, machine learning model 120 may be trained with training data that identifies different radiofrequencies, different types of ores associated with the different radiofrequencies, and different intensities associated with the different radiofrequencies, For instance, the training data may include data identifying a first radio frequency (or a first range of radio frequencies), data indicating that the first radio frequency (or the first range of radio frequencies) identifying a first type of ore, and data indicating that a first intensity identifies a first concentration of the first type of ore. The training data may include data identifying a second radio frequency (or a second range of radio frequencies), data indicating that the second radio frequency (or the second range of radio frequencies) identifies a second type of ore, and data indicating that a second intensity identifies a second concentration of the second type of ore. Accordingly, machine learning model 120 may be trained to identify different predicted types of ores and predicted concentrations of the different predicted types of ores based on different radio frequencies and different intensities identified by the dust data.

In some implementations, the training data may identify co-occurrences of ores. For example, the training data may indicate that a first type of ore is typically found with a second type ore. Additionally, or alternatively, the training data may indicate a concentration of the first type of ore and a concentration of the second type of ore. As an example, the training data may indicate that copper is typically found with zinc. Accordingly, based on detecting copper at a particular location as a result of analyzing the dust data, machine learning model 120 may determine (or in other words predict) that zinc is to be detected at the particular location. Additionally, or alternatively, machine learning model 120 may determine a concentration of zinc. In some implementations, mobile unit 110 may store, in a data store, information regarding dust 130. For example, mobile unit 110 may store, in the data store, the dust data regarding dust 130 (e.g., data regarding dust samples) along with information identifying a location of dust 130 within the mine. The information may be stored along with results of the analysis/prediction of machine learning model 120 (e.g., amount of ore A or amount of ore B, among other examples).

Material processing device 140 may analyze material excavated (e.g., by mining machine 105) at the location of dust 130 (e.g., a location of mobile unit 110). In some examples, the material may be transported by mining machine 105 to material processing device 140. If machine learning model 120 determines predicted concentrations/amounts of ores that exceeds or that does not meet a concentration/amount threshold, then the material may be transported to a remote lab/testing site for verification. For example, the material may be provided to material processing device 140 for verification.

Based on analyzing the material, material processing device 140 may determine actual types of ores and/or actual concentration of the actual types of ores. In some situations, the actual types of ores and/or actual concentration of the actual types of ores may be different than the predicted types of ores and/or the predicted concentration of the predicted types of ores. In this regard, material processing device 140 may detect false positive feedback and/or false negative feedback with respect the predicted types of ores and/or the predicted concentration of the predicted types of ores.

For example, material processing device 140 may compare the actual types of ores and/or actual concentration of the actual types of ores and the predicted types of ores and/or the predicted concentration of the predicted types of ores to verify an accuracy of the information predicted by machine learning model 120. Based on the comparison, material processing device 140 may detect a false positive if the predicted types of ores are not found in the material and/or if the actual concentration of the actual types of ores is less than the predicted concentration of the predicted types of ores. Based on the comparison, material processing device 140 may detect a false negative if the actual types of ores were not included in the predicted types of ores and/or if the actual concentration of the actual types of ores exceeds the predicted concentration of the predicted types of ores.

In some implementations, material processing device 140 may generate digging information that may be used to retrain machine learning model 120 with more accurate labels so that machine learning model 120 can more accurately detect concentrations/amounts. The digging information may identify the actual types of ores and the actual concentration of the actual types of ores. Accordingly, the digging information may indicate whether the predicted types of ores were located as a result of performing the digging operation at the location. In some examples, in the event material processing device 140 detects a false positive or a false negative, the digging information may associate the actual types of ores with the frequencies identified by the dust data and/or associate the actual concentration of the actual types of ores with the intensities identified by the dust data. The digging information may be used to retrain machine learning model 120.

As an example, if mobile unit 110 determines 30% tin, 5% zinc, 1% silver from the location (e.g., a specific part of the mine) and a goal of the mining operation is to obtain any concentration above 0.5% silver, information regarding dust 130 may be stored as a sample of interest and then dust 130 may be sent to material processing device 140 for analysis. The mining operation may then begin at the location for further exploration. In some examples, mobile unit 110 may cause mining machine 105 to initiate the mining operation. For example, mobile unit 110 may generate mining information and provide the mining information to mining machine 105. The mining information may identify the predicted types of ores, the predicted concentration of the predicted types of ores, and/or the location. If material processing device 140 determines that the sample actually included 30% tin, 4% zinc, and 0.03% silver, the information may be used to retrain machine learning model 120 to enhance accuracy. For example, the digging information may associate the actual types of ores with the frequencies identified by the dust data and/or associate the actual concentration of the actual types of ores with the intensities identified by the dust data.

Implementations described herein are directed to using dust to make a prediction, using results of analysis of the material (excavated) as feedback about predictions and ML tuning, using a mining machine as a mule for power and fuel, and using a mobile unit (e.g., an agile sensor robot) that can be easily replaced.

The number and arrangement of components shown in FIG. 1 are provided as an example.

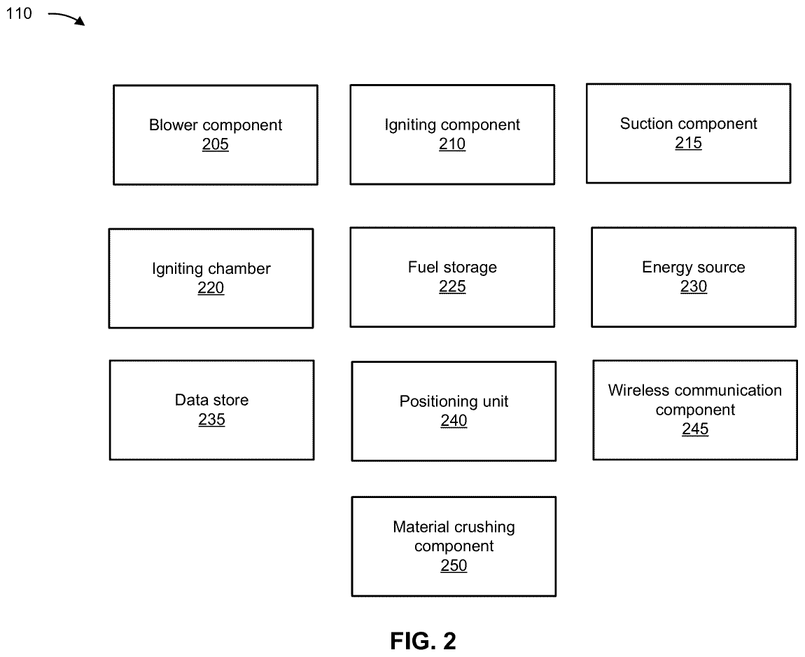

FIG. 2 is a diagram of an example mobile unit 110 described herein. As shown in FIG. 2, a blower component 205, an igniting component 210, a suction component 215, an igniting chamber 220, a fuel storage 225, an energy source 230, a data store 235, a positioning unit 240, a wireless communication component 245, and a material crushing component 250. Blower component 205 may include a component that is used to blow up dust at a location of mobile unit 110. For example, blower component 205 may include a mechanical device that creates a current of air to cause movement of dust. Igniting component 210 may include a component that is used to ignite the dust to generate a flame. For example, igniting component 210 may include a device that creates a controlled flame. For instance, igniting component 210 may include a lighter or a ranged incendiary device designed to project a controllable jet of fire, among other examples. In some situations, igniting component 210 may include a laser. Suction component 215 may include a component that is used to suction dust into igniting chamber 220. Igniting chamber 220 may include a chamber in which dust may be ignited. For example, igniting chamber 220 may include an enclosure that may facilitate dust being ignited. Igniting chamber 220 nay include a material that enables the dust to bed ignite to generate a flame (e.g., without causing damage to mobile unit 110).

Fuel storage 225 may store fuel or other flammable material that may be used to ignite the dust. The fuel may include gas, methane, or hydrocarbon, among other examples. In some examples, fuel storage 225 may dispense the fuel or other flammable material. Additionally, or alternatively, igniting component 210 may dispense the fuel or other flammable material. Energy source 230 may supply power to facilitate operation of mobile unit 110. Energy source 230 may supply electrical power, solar power, or a combination of electrical power and solar power. As an example, energy source 230 may include a battery, a solar panel, or a combination of the battery and the solar panel. In some situations, the battery may include a rechargeable battery. In this regard, the battery may be recharged by mining machine 105. For example, mining machine 105 may include a charging component that recharges batteries.

Data store 235 may be used to store ore information, information generated by machine learning model 120, and digging information. In some examples, ore information identifies a type of ore to be detected in the mine, a concentration of a type of ore, a desired combination of ores, or an undesired combination of ores, among other examples. Data store 235 may include a data structure, a database, a table, and/or a linked list.

Positioning unit 240 may include one or more devices that are capable of receiving, generating, storing, processing, and/or providing signals that may be used to determine a location of mining machine 105 and/or mobile unit 110 at a location, among other examples. As an example, positioning unit 240 may generate location data that may be used by mobile unit 110 to determine a location of mobile unit 110.

Wireless communication component 245 may include one or more devices that are capable of communicating with mining machine 105, among other examples. As an example, wireless communication component 245 may provide location data to mining machine 105. Wireless communication component 116 may include a transceiver, a separate transmitter and receiver, and/or an antenna, among other examples. Wireless communication component 116 may communicate with mining machine 105 and/or the one or more machines using a short-range wireless communication protocol such as, for example, BLUETOOTH® Low-Energy, BLUETOOTH®, Wi-Fi, near-field communication (NFC), Z-Wave, ZigBee, or Institute of Electrical and Electronics Engineers (IEEE) 802.154, among other examples.

Material crushing component 250 may include a component that is used to break material of a particular size into pieces of a smaller size, thereby creating sample of dust to be tested. In some examples, the material may be material in the mine. In some examples, the sample of dust may be tested by material processing device 140. In some examples, material crushing component 250 may break down the material by applying pressure or impact force. In some implementations, material crushing component 250 may include a member extending from a body of mobile unit 110. For example, material crushing component 250 may include an arm, such as a robotic arm. In some implementations, material crushing component 250 may include a crusher.

The number and arrangement of components shown in FIG. 2 are provided as an example. Mobile unit 110 may include additional components, fewer components, different components, or differently arranged components than those shown in FIG. 2. Additionally, or alternatively, a set of components (e.g., one or more components) of mobile unit 110 may perform one or more functions described as being performed by another set of components of mobile unit 110.

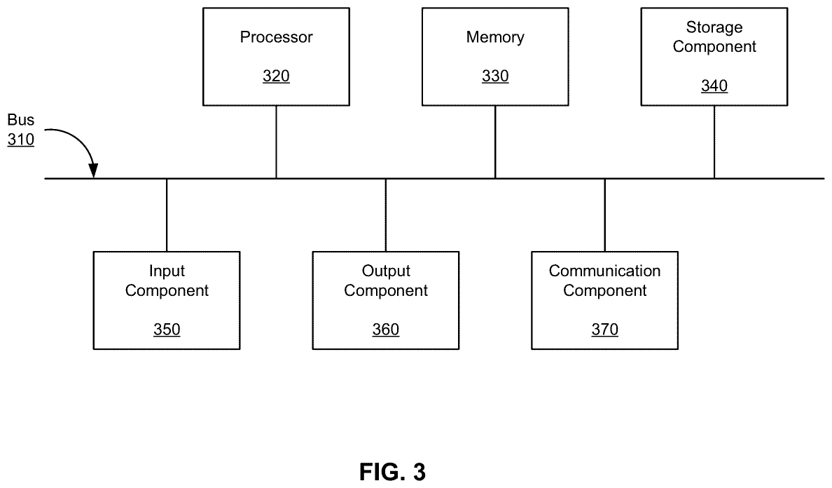

FIG. 3 is a diagram of example components of a device 300, which may correspond to mining machine 105 and/or mobile unit 110. In some implementations, mining machine 105 and/or mobile unit 110 may include one or more devices 300 and/or one or more components of device 300. As shown in FIG. 3, device 300 may include a bus 310, a processor 320, a memory 330, a storage component 340, an input component 350, an output component 360, and a communication component 370.

Bus 310 includes a component that enables wired and/or wireless communication among the components of device 300. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform a function. Memory 330 includes a random access memory, a read only memory, and/or another type of memory (e.g., a flash memory, a magnetic memory, and/or an optical memory).

Storage component 340 stores information and/or software related to the operation of device 300. For example, storage component 340 may include a hard disk drive, a magnetic disk drive, an optical disk drive, a solid state disk drive, a compact disc, a digital versatile disc, and/or another type of non-transitory computer-readable medium. Input component 350 enables device 300 to receive input, such as user input and/or sensed inputs. For example, input component 350 may include a touch screen, a keyboard, a keypad, a mouse, a button, a microphone, a switch, a sensor, a global positioning system component, an accelerometer, a gyroscope, and/or an actuator. Output component 360 enables device 300 to provide output, such as via a display, a speaker, and/or one or more light-emitting diodes. Communication component 370 enables device 300 to communicate with other devices, such as via a wired connection and/or a wireless connection. For example, communication component 370 may include a receiver, a transmitter, a transceiver, a modem, a network interface card, and/or an antenna.

Device 300 may perform one or more processes described herein. For example, a non-transitory computer-readable medium (e.g., memory 330 and/or storage component 340) may store a set of instructions (e.g., one or more instructions, code, software code, and/or program code) for execution by processor 320. Processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

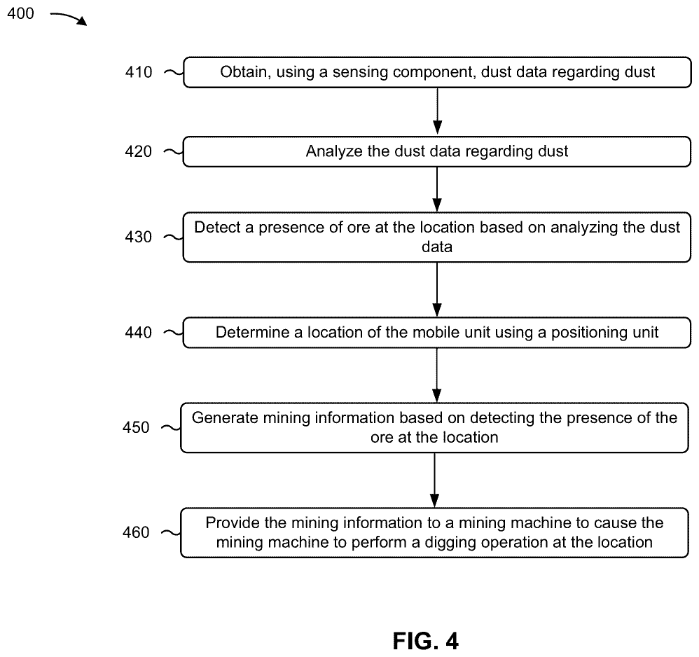

FIG. 4 is a flowchart of an example process 400 associated with autonomous mine monitoring. In some implementations, one or more process blocks of FIG. 4 may be performed by a mobile unit (e.g., mobile unit 110). In some implementations, one or more process blocks of FIG. 4 may be performed by another device or a group of devices separate from or including the mobile unit, such as a mining machine (e.g., mining machine 105) or a material processing device (e.g., material processing device 140), among other examples. Additionally, or alternatively, one or more process blocks of FIG. 4 may be performed by one or more components of device 300, such as processor 320, memory 330, storage component 340, input component 350, output component 360, and/or communication component 370.

As shown in FIG. 4, process 400 may include obtaining, using a sensing component, dust data regarding dust (block 410). For example, the mobile unit may obtain the dust data using a spectrometer. For example, the dust data may be an output of the spectrometer. In other words, the spectrometer may generate the dust data. In some situations, the mobile unit may receive ore information and may be deployed to a location in a mine. The mobile unit may receive the ore information from the mining machine, the material processing device, or a user device of an operator associated with the mining machine or associated with the material processing device, among other examples. The mobile unit may receive the ore information using a wireless communication component (e.g., wireless communication component 245). As explained herein, the ore information may identify a type of ore to be detected in the mine, a concentration of a type of ore, a desired combination of ores, or an undesired combination of ores, among other examples.

At the location, in some situations, the mobile unit may dispense fuel (from fuel storage 225) on dust and blow up the dust using blower component 205. The mobile unit may ignite the dust to generate a flame. In some situations, the mobile unit may suction the dust using a blower into a chamber (e.g., using blower component 205 into igniting chamber). The mobile unit may ignite the dust to generate the flame within the chamber. The mobile unit may use the sensing component to measure frequencies and intensities of the frequencies. For example, as explained herein, the sensing component may include a photo sensor for measuring a light spectrum of the dust when the dust burns. The dust data may be an output of the sensing component and the dust data may include data identifying one or more frequencies, one or more intensities of the one or more frequencies, and acorresponding spectral energy at the one or more frequencies. In some examples, the dust data may include a spectrum. For instance, the spectrum may be a graphical representation indicating an intensity of light at different frequencies, essentially displaying how much light is absorbed or emitted by a sample across a range of frequencies of light.

In some examples, the sensing component may determine a nuclear magnetic resonance of the dust. In this regard, the nuclear magnetic resonance may be determined without igniting the dust. In some examples, an output of the sensing component determining the nuclear magnetic resonance of the dust may include a nuclear magnetic resonance. In this regard, the dust data may include data regarding the nuclear magnetic resonance spectra. The mobile unit may use the sensing component to measure radiofrequencies of the dust and intensities of the radiofrequencies. The dust data may indicate chemical composition and structure of dust particles.

Referring back to FIG. 4, process 400 may include analyzing the dust data regarding the dust (block 420). For example, the mobile unit may analyze the dust data at a location. In some implementations, the dust data may be analyzed using a machine learning model (e.g., machine learning model 120). The machine learning model may be trained to analyze the dust data to determine presence of ores. For example, the machine learning model may receive the dust data as input and provide, as an output, different predicted types of ores and predicted concentrations of the different predicted types of ores. For instance, as explained herein, the machine learning model may be trained to identify the different predicted types of ores based on the different frequencies or range of frequencies identified by the dust data. Additionally, or alternatively, the machine learning model may be trained to identify predicted concentrations of the different predicted types of ores based on the different intensities identified by the dust data.

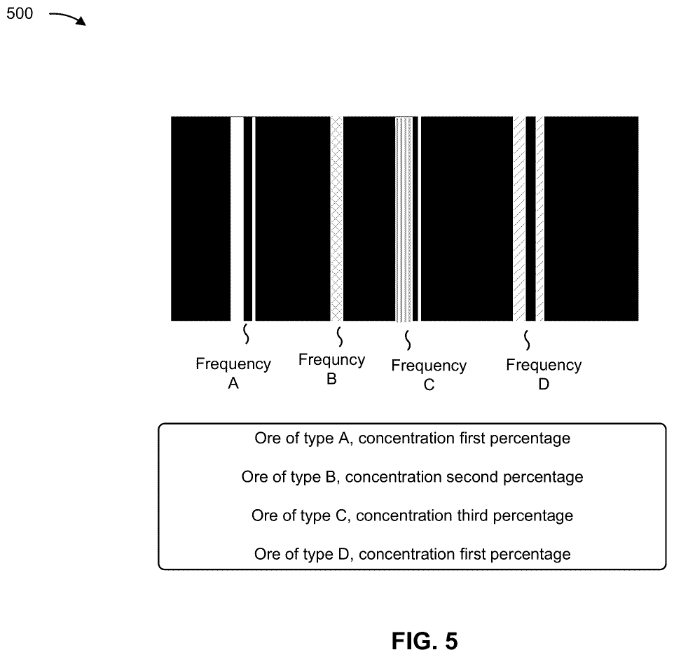

An example of dust data 500 is illustrated in FIG. 5. As shown in FIG. 5, dust data 500 may indicate different frequencies or ranges of frequencies. The different frequencies or ranges of frequencies may indicate different types of ores. As an example, the machine learning model that frequency A is indicative of ore of type A, that frequency B is indicative of ore of type B, that frequency C is indicative of ore of type C, and that frequency D is indicative of ore of type D. Accordingly, the predicted types of ores may include ore of type A, ore of type B, ore of type C, and ore of type D. Dust data 500 may indicate intensities of the different frequencies or ranges of frequencies. Accordingly, based on the intensities, the machine learning model may determine that a concentration of a first percentage for ore of type A, a concentration of a second percentage for ore of type B, a concentration of a third percentage for ore of type C, and a concentration of a fourth percentage for ore of type D.

As further shown in FIG. 4, process 400 may include detecting a presence of ore at the location based on analyzing the dust data (block 430). For example, the mobile unit may detect a presence of ore at the location based on analyzing the dust data. For example, as described above in connection with block 410, the machine learning model may detect ore of type A, ore of type B, ore of type C, and ore of type D.

As further shown in FIG. 4, process 400 may include determining a location of the mobile unit using a positioning unit (block 440). For example, the mobile unit may determine the location of the mobile unit using a positioning unit (e.g., positioning unit 240). In some implementations, the mobile unit may compare the output of the machine learning model and the ore information to determine whether the predicted types of ores and/or the predicted concentrations were identified by the ore information. Based on the comparison, if the mobile unit determines that the predicted types of ores and/or the predicted concentrations were identified by the ore information, the mobile unit may determine the location of the mobile unit.

As further shown in FIG. 4, process 400 may include generating mining information based on detecting the presence of the ore at the location (block 450). For example, the mobile unit may generate mining information based on detecting the presence of the ore at the location. In some implementations, the mobile unit may compare the output of the machine learning model and the ore information to determine whether the predicted types of ores and/or the predicted concentrations were identified by the ore information. Based on the comparison, if the mobile unit determines that the predicted types of ores and/or the predicted concentrations were identified by the ore information, the mobile unit may generate the mining information. In some implementations, the mining information indicates the presence of the ore at the location. In some implementations, the mining information identifies the location.

As further shown in FIG. 4, process 400 may include providing the mining information to a mining machine to cause the mining machine to perform a digging operation at the location (block 460). For example, the mobile unit may provide the mining information to the mining machine to cause the mining machine to perform a digging operation at the location. In some implementations, the mobile unit may provide the mining information as instructions to cause the mining machine to perform the digging operation. In other words, the mobile unit may provide the mining information to control an operation of the mining machine.

In some implementations, if the mobile unit determines that the predicted types of ores and/or the predicted concentrations were identified by the ore information, the mobile unit and/or the mining machine may collect a sample of dust at the location. The sample of dust may be provided to the material processing device for analysis. For example, the sample of dust may be provided to the material processing device to determine actual types of ores and/or actual concentrations of the actual types of ores at the location. In some implementations, the mobile unit may provide, to the material processing device, information identifying the predicted types of ores and the predicted concentrations of the predicted types of ores. In this regard, the material processing device may compare the actual types of ores and the predicted types of ores and/or may compare the actual concentrations and the predicted concentrations. In some situations, based on the comparison, the material processing device may detect false positive feedback and/or false negative feedback. If the material processing device detects false positive feedback and/or false negative feedback, the material processing device may generate digging information that may be used to re-trained the machine learning model. For example, the digging information may associate information identifying the actual types of ores with the frequencies identified by the dust data. Additionally, or alternatively, the digging information may associate information identifying the actual concentrations with the intensities identified by the dust data.

In some implementations, analyzing the dust data at the location comprises igniting the dust at the location to generate a flame, and analyzing a spectral energy of the flame.

In some implementations, analyzing the spectral energy comprises using a mass spectrometer to obtain the dust data, wherein the dust data indicates the spectral energy of the flame, and analyzing the data using the machine learning model.

In some implementations, analyzing the spectral energy comprises using an infrared spectrometer to obtain the dust data, wherein the dust data indicates the spectral energy of the flame, and analyzing the data using the machine learning model.

In some implementations, detecting the presence of the ore comprises detecting a presence of ore of a first type when the spectral energy is a first spectral energy, and detecting a presence of ore of a second type when the spectral energy is a second spectral energy.

In some implementations, analyzing the dust data at the location comprises analyzing a nuclear magnetic resonance of the dust.

In some implementations, process 400 includes receiving digging information from the mining machine based on the mining machine performing the digging operation at the location, wherein the digging information indicates whether the ore was located as a result of performing the digging operation at the location, and-training the machine learning model using the digging information.

In some implementations, detecting the presence of ore comprises detecting that an amount of the ore satisfies a threshold amount, and detecting the presence of ore based on detecting that the amount of the ore satisfies the threshold amount.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems or methods described herein may be implemented in different forms of hardware, firmware, or a combination of hardware and software. The actual control hardware or software code used to implement these systems or methods is not limiting of the implementations. Thus, the operation and behavior of the systems or methods are described herein without reference to specific software code-it being understood that software and hardware can be used to implement the systems or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims or disclosed in the specification, these combinations are not intended to limit the disclosure of various implementations. In fact, many of these features may be combined in ways not specifically recited in the claims or disclosed in the specification. Although each dependent claim listed below may directly depend on only one claim, the disclosure of various implementations includes each dependent claim in combination with other claims in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein is to be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “or,” unless explicitly stated otherwise (e.g., if used in combination with “either” or “only one of”).

What is claimed is:

1. A method performed by a mobile unit, the method comprising:
obtaining, using a sensing component of the mobile unit, dust data regarding dust;
analyzing, by the mobile unit, the dust data,
wherein the dust data is analyzed using a machine learning model trained to analyze the dust data to determine presence of ores;
detecting, by the mobile unit, a presence of ore at the location based on analyzing the dust data;
determining a location of the mobile unit using a positioning unit of the mobile unit;
generating, by the mobile unit, mining information based on detecting the presence of the ore at the location,
wherein the mining information identifies the location; and
providing, by the mobile unit, the mining information to a mining machine to cause the mining machine to perform a digging operation at the location.

2. The method of claim 1, wherein analyzing the dust data at the location comprises:
igniting the dust at the location to generate a flame; and
analyzing a spectral energy of the flame.

3. The method of claim 2, wherein analyzing the spectral energy comprises:
using a mass spectrometer to obtain the dust data, wherein the dust data indicates the spectral energy of the flame; and
analyzing the dust data using the machine learning model.

4. The method of claim 2, wherein analyzing the spectral energy comprises:
using an infrared spectrometer to obtain the dust data, wherein the dust data indicates the spectral energy of the flame; and
analyzing the dust data using the machine learning model.

5. The method of claim 1, wherein detecting the presence of the ore comprises:
detecting a presence of ore of a first type when the dust data indicates a first spectral energy; and
detecting a presence of ore of a second type when the dust data indicates a second spectral energy.

6. The method of claim 1, wherein analyzing the dust data at the location comprises:
analyzing a nuclear magnetic resonance of the dust.

7. The method of claim 1, further comprising:
receiving digging information,
wherein the digging information indicates whether the ore was located as a result of performing the digging operation at the location; and
re-training the machine learning model using the digging information.

8. The method of claim 1, wherein detecting the presence of ore comprises:
detecting that an amount of the ore satisfies a threshold amount; and
detecting the presence of ore based on detecting that the amount of the ore satisfies the threshold amount.

9. A system comprising:
a mobile unit to:
obtain, using a sensing component, dust data regarding dust at a location;
analyze the dust data,
wherein the dust data is analyzed using a machine learning model trained to analyze the dust data to determine presence of ores;
detect a presence of ore at the location based on analyzing the dust data;
generate mining information based on detecting the presence of the ore at the location,
wherein the mining information identifies the location;
provide the mining information to a mining machine to cause the mining machine to perform a digging operation at the location; and
re-train the machine learning model based on digging information received from the mining machine as a result of the mining machine performing the digging operation at the location.

10. The system of claim 9, wherein, to analyze the dust data at the location, the mobile unit is to:
analyze a nuclear magnetic resonance of the dust.

11. The system of claim 10, wherein, to detect the presence of ore, the mobile unit is to:
detect that an amount of the ore satisfies a threshold amount; and
detect the presence of ore based on detecting that the amount of the ore satisfies the threshold amount.

12. The system of claim 9, wherein, to analyze the dust data at the location, the mobile unit is to:
analyze a spectrum of frequencies.

13. The system of claim 9, wherein, to analyze the dust data at the location, the mobile unit is to:
ignite the dust at the location to generate a flame; and
analyzing a spectral energy of the flame.

14. The system of claim 13, wherein, to analyze the dust data at the location, the mobile unit is to:
use a spectrometer to obtain the dust data, wherein the dust data indicates the spectral energy of the flame; and
analyzing the data using the machine learning model.

15. A non-transitory computer-readable medium storing a set of instructions, the set of instructions comprising:
one or more instructions that, when executed by one or more processors of a mobile unit, cause the mobile unit to:
analyze dust data of dust at a location,
wherein the dust data is analyzed using a machine learning model trained to analyze the dust data to determine presence of ores;
detect a presence of ore at the location based on analyzing the dust data;
generate mining information based on detecting the presence of the ore at the location,
wherein the mining information identifies the location; and
provide the mining information to a mining machine to cause the mining machine to perform a digging operation at the location.

16. The non-transitory computer-readable medium of claim 15, wherein the one or more instructions, that cause the mobile unit to analyze the dust data at the location, cause the mobile unit to:
ignite the dust at the location to generate a flame; and
analyze a spectral energy of the flame.

17. The non-transitory computer-readable medium of claim 16, wherein the one or more instructions, that cause the mobile unit to analyze the spectral energy, cause the mobile unit to:
use a mass spectrometer to obtain the dust data, wherein the dust data indicates the spectral energy of the flame; and
analyze the data using the machine learning model.

18. The non-transitory computer-readable medium of claim 16, wherein the one or more instructions, that cause the mobile unit to analyze the spectral energy, cause the mobile unit to:
use an infrared spectrometer to obtain the dust data, wherein the dust data indicates the spectral energy of the flame; and
analyze the data using the machine learning model.

19. The non-transitory computer-readable medium of claim 16, wherein the one or more instructions further cause the mobile unit to one or more of
detect a presence of ore of a first type when the spectral energy is a first spectral energy; and
detect a presence of ore of a second type when the spectral energy is a second spectral energy.

20. The non-transitory computer-readable medium of claim 15, wherein the one or more instructions, that cause the mobile unit to analyze the dust data at the location, cause the mobile unit to:
analyze a nuclear magnetic resonance of the dust, and
wherein the one or more instructions, that cause the mobile unit to detect the presence of ore, cause the mobile unit to:
detect that an amount of the ore satisfies a threshold amount; and
detect the presence of ore based on detecting that the amount of the ore satisfies the threshold amount.

21. The non-transitory computer-readable medium of claim 15, wherein the one or more instructions further cause the mobile unit to:
receive digging information indicating whether the ore was located as a result of performing the digging operation at the location; and
training the machine learning model using the digging information.
